(19) United States
(12) Patent Application Publication
(10) Pub. No.: US 2026/0116543 A1
(43) Pub. Date: Apr. 30, 2026

(54) ARMREST PROVIDED WITH A ROTATIONAL ADJUSTMENT SYSTEM

(71) Applicant: Safran Seats, Plaisir (FR)

(72) Inventor: Michaël Leveque, Moissy-Cramayel (FR)

(73) Assignee: Safran Seats, Plaisir (FR)

(21) Appl. No.: 19/150,884

(22) PCT Filed: Jan. 22, 2024
(86) PCT No.: PCT/EP2024/051369

§ 371 Date: Jul. 24, 2025

(30) Foreign Application Priority Data
Jan. 30, 2023 (FR) 2300823

(51) Int. Cl. B64D 11/06

(52) U.S. Cl. CPC B64D 11/0644; B64D 11/064; B64D 11/0641

(57) ABSTRACT

The invention relates to an armrest for a seat, comprising a disengagement device that can be actuated by an actuation means, said disengagement device being able to adopt:
a locked state in which the notched portion of the movable element bears against the notched portion of the stationary element in an angular abutment position so as to block rotation of the armrest body in a first direction of rotation while allowing rotation of the armrest body in a second direction of rotation; and
an unlocked state in which the notched portion of the movable element is axially remote from the notched portion of the stationary element so as to allow rotation of the armrest body in the first direction of rotation in order to enable the angular abutment position to be modified.

The present invention relates to an armrest provided with a rotation adjustment system. The invention finds a particularly advantageous, but not exclusive, application with airplane seats, in particular “first class” or “business class” airplane seats.

In a manner known per se, a business class seat comprises a seating pan and a backrest hinged to the seating pan by means of a pivot connection. The seat may also include a legrest hinged to the seat by means of a pivot connection. The seating pan and backrest are mounted on a seat structure to be fixed to the floor of an aircraft by means of fixing rails.

A seat is advantageously provided with a kinematics so as to be movable between a raised position and a bed position. In the raised position, the backrest forms a non-zero angle relative to the seating pan. The raised position is a position suitable for the takeoff, landing, or parking phase of the aircraft. In the bed position, the backrest and the seating pan and, if applicable, a footrest are located in an extension of the seating pan so as to form a substantially horizontal sleeping surface for the passenger. Intermediate comfort positions are also offered, such as the “reclined” position in which the seat backrest is strongly inclined backwards. Generally, these intermediate positions are obtained by tilting the pivoting backrest around a horizontal axis and perpendicular to an extension axis of the seat.

The seat may be provided with a movable armrest capable of taking several positions according to the seat orientation. It is desirable to keep the armrest in a horizontal position when the backrest moves backward towards a comfortable seat position.

Document U.S. Pat. No. 6,467,847 describes an armrest comprising a mounting shaft and an adjustment mechanism between the two ends of the armrest. The mounting shaft contains two end slots. The adjustment mechanism is capable of memorizing an angular position of the armrest so as to return the armrest to the memorized position.

Document EP0655365 describes an armrest folding mechanism applicable to vehicle seat armrests. This mechanism allows a first horizontal position and a second fully folded position. The transition from one position to the other is carried out by pressing a button.

Document U.S. Pat. No. 5,597,209 describes a ratchet mechanism for adjusting the tilt of a vehicle seat armrest. This mechanism is able to move the armrest from a high to a low position without requiring a button to be pressed.

These state-of-the-art devices do not however allow a fine angular increment of the armrest.

The objective of the invention is in particular to effectively remedy this drawback by offering a seat armrest comprising:
an armrest arm,
an armrest body able to support a part of a passenger's body,
an axis carried by the armrest arm and defining an axis of rotation of the body armrest relative to the armrest arm,
a device for adjusting the rotation of the armrest body comprising:
a fixed element fixed to the armrest arm, said fixed element comprising a notched portion,
a movable element linked in rotation to the armrest body while being movable in translation relative to the armrest body along the axis of rotation of the armrest, said movable element comprising a notched portion whose shape is complementary to that of the notched portion of the fixed element, and
a disengaging device actuable by an actuating means, said disengaging device being capable of taking:
a locked state in which the notched portion of the movable element bears against the notched portion of the fixed element in an angular stop position so as to block the rotation of the armrest body in a first direction of rotation while allowing the rotation of the armrest body in a second direction of rotation opposite to the first direction of rotation, and
an unlocked state in which the notched portion of the movable element is axially spaced from the notched portion of the fixed element so as to allow the rotation of the armrest body in the first direction of rotation so as to modify the angular stop position,
a transition from the locked state to the unlocked state being possible thanks to a translational movement of the movable element along the axis of rotation of the armrest body.

The invention thus allows, thanks to the notched portions of the fixed element and the movable element, to carry out a precise angular adjustment of the armrest so as to ensure that the armrest can extend in a horizontal plane whatever the position of the seat and the corresponding inclination of the backrest.

According to one embodiment of the invention, the disengaging device comprises a disengaging rod movable in translation relative to the armrest body and a connecting rod having a first end movable in rotation relative to the disengaging rod and a second end movable in rotation relative to the movable element.

According to one embodiment of the invention, the disengaging device comprises an elastic return member between the disengaging rod and the armrest body.

According to one embodiment of the invention, each of the notched portion of the element movable and the notched portion of the fixed element has a plurality of stepped notches.

According to one embodiment of the invention, the notched portion of the fixed element is made on an axially projecting part of the fixed element and the notched portion of the movable element is made on an axially projecting part of the movable element.

According to one embodiment of the invention, the notched portion of the fixed element and the notched portion of the movable element are made on helical-shaped faces.

According to one embodiment of the invention, the notched portions are sized so that an angular pitch of the armrest body is comprised between 2 and 5 degrees and preferably is of 2.5 degrees.

According to one embodiment of the invention, the actuating means is a button on one side of the armrest body.

According to one embodiment of the invention, said armrest comprises a friction disc fixed on the armrest arm cooperating with the armrest body.

According to one embodiment of the invention, the armrest body carries rods respectively inserted into guide slots of corresponding shape on an external periphery of the movable element.

According to one embodiment of the invention, the armrest body is covered by a finishing covering.

The objective of invention is also an assembly comprising:
an airplane seat, and
an armrest as previously defined.

According to one embodiment of the invention, the airplane seat is movable between a raised position and a bed position.

The invention further relates to an aircraft comprising an assembly such as previously defined.

The invention will be better understood and other characteristics and advantages will appear by reading the following detailed description, which includes embodiments given for illustrative purposes with reference to the accompanying figures, presented as way of non-limiting examples, which may serve to complete the understanding of the present invention and the description of its implementation and eventually contribute to its definition, wherein:

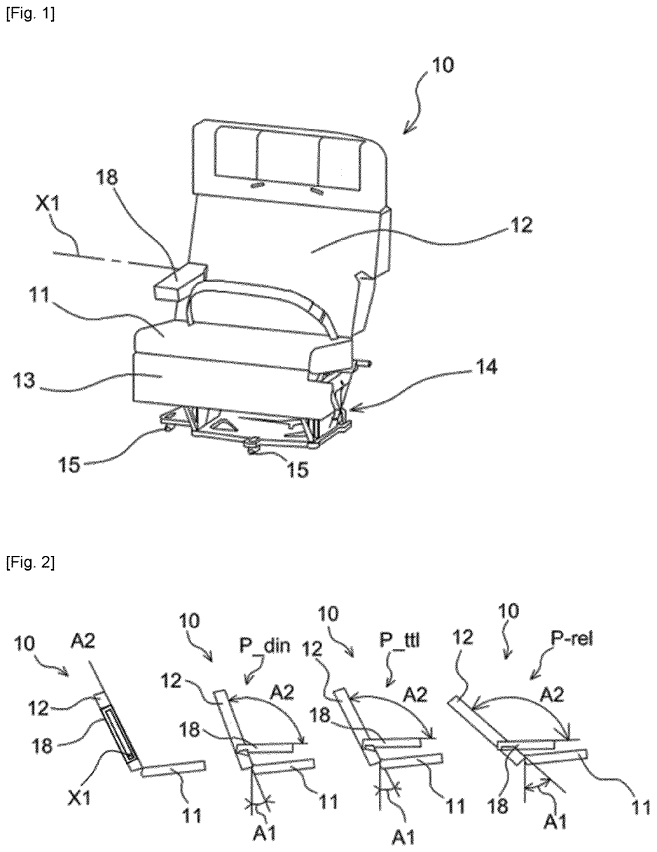

FIG. 1 is a perspective view of a seat provided with a rotation adjustable armrest according to the invention;

FIG. 2 shows side views of different positions that the armrest according to the invention can take according to the position of the seat in FIG. 1;

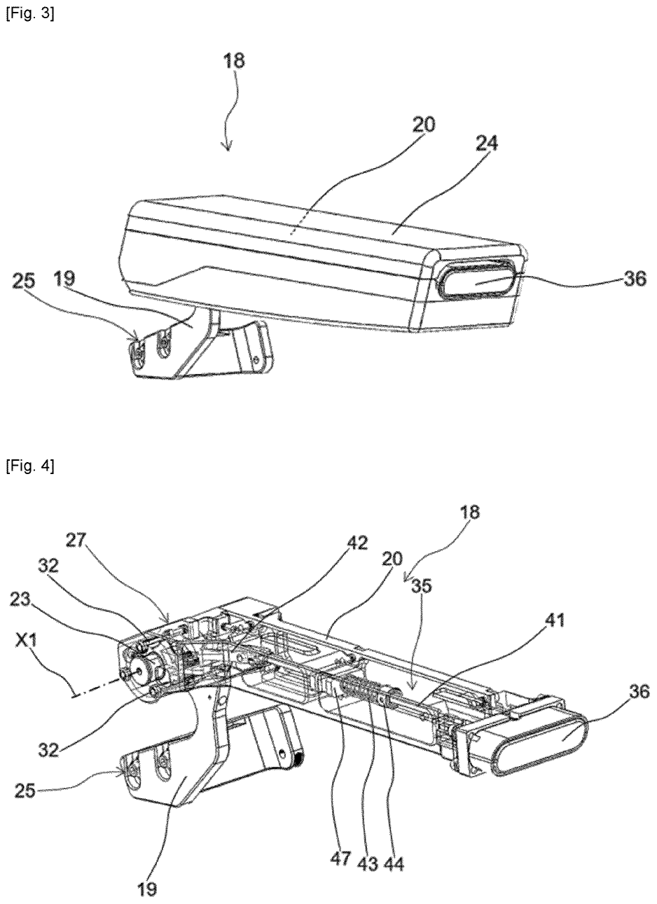

FIG. 3 is a perspective view of a rotation adjustable armrest according to the invention;

FIG. 4 is a perspective view of a rotation adjustable armrest according to the invention without the finishing covering and whose internal mechanism is shown through;

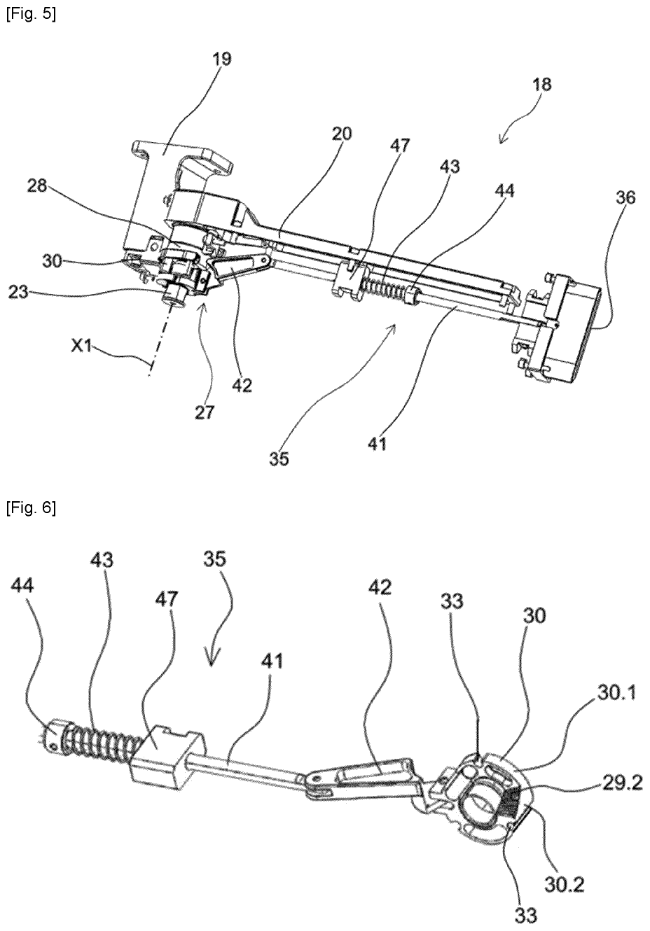

FIG. 5 is a top perspective view of internal components of a rotation adjustable armrest according to the invention;

FIG. 6 is a perspective view of a disengaging device for an armrest according to the invention;

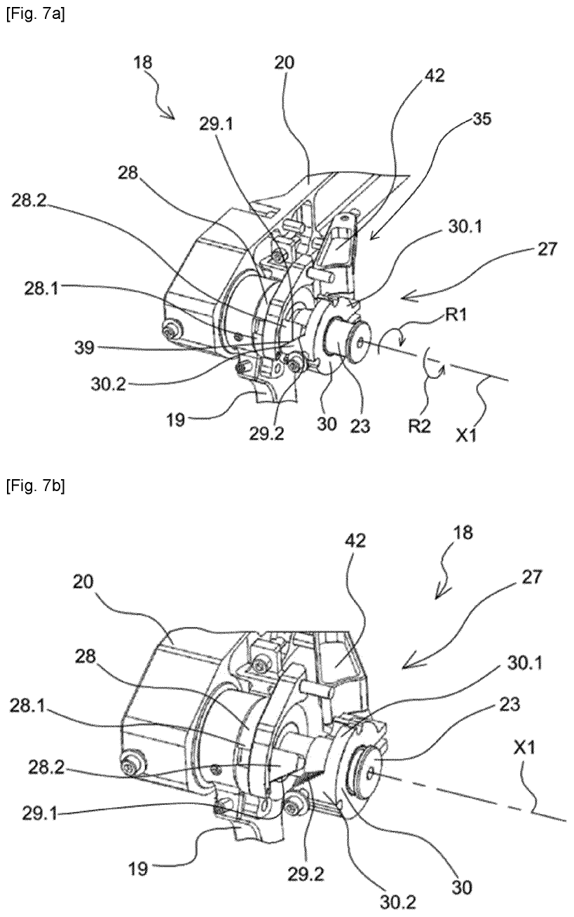

FIGS. 7a and 7b are partial perspective views of an armrest according to the invention when the disengaging device is in the locked state and in the unlocked state respectively;

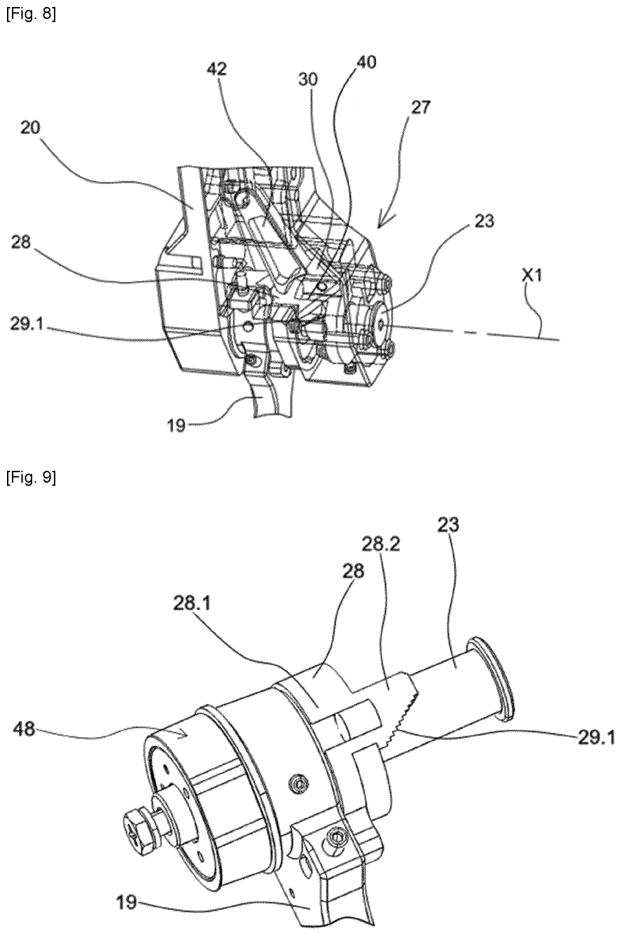

FIG. 8 is a partial perspective view illustrating the stopping process for the rotation adjustment device for the armrest when said armrest is in a raised position;

FIG. 9 is a perspective view of an armrest arm according to the invention provided with a friction disc for cooperating with the armrest body;

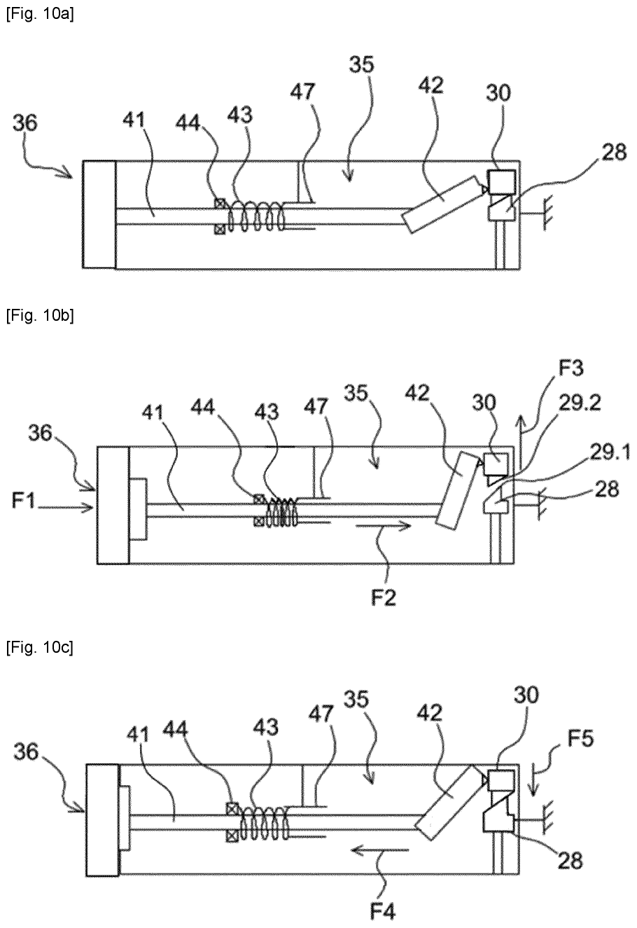

FIGS. 10a, 10b, and 10c are schematic top views illustrating the operation of the armrest disengaging device according to the invention;

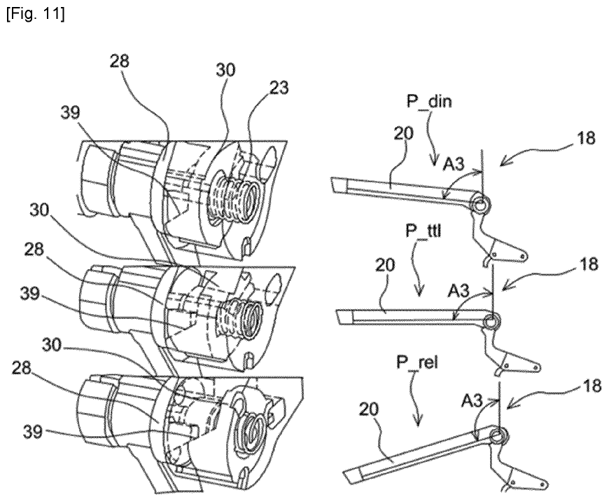

FIG. 11 illustrates a variation of the overlapping zone between a fixed element and a movable element of the rotation adjustment device as a function of different angular positions of the armrest.

It should be noted that in the figures the structural elements and/or functional elements common to the different embodiments may have the same references. Thus, unless otherwise stated, such elements have identical structural, dimensional and material properties.

FIG. 1 shows a seat 10, in particular for an aircraft cabin, comprising a seating pan 11 and a backrest 12 articulated relative to the seating pan 11 by means of a pivot connection with a horizontal axis. If necessary, the seat 10 may comprise a legrest 13 articulated relative to the seating pan 11 by means of a pivot connection with a horizontal axis.

The seat 10 also comprises a seat structure 14 to be fixed on rails of an aircraft cabin. For this purpose, the seat structure 14 comprises locks 15 able to cooperate with the rails of the aircraft cabin.

The seat 10 is advantageously provided with a kinematics so as to be mobile between a raised position and a bed position. The kinematics comprises a set of actuators, connecting parts, and joints for the relative movement of the different components of the seat when moving from one position to another. The seat 10 can also take intermediate positions.

As illustrated in FIG. 2, the seat 10 may in particular take a meal position P_din in which the backrest 12 is sharply raised so that the passenger is comfortably seated so as to enjoy her/his meal, a TTL position (Taxi, Take-off, landing) referenced P_ttl taken by the seat 10 in the take-off, landing or parking phases of the aircraft, or a reclined position P_rel in which the backrest 12 of the seat 10 is strongly inclined rearward. In the meal, TTL and reclined positions, the backrest 12 can form for example an angle A1 of 15 degrees, 20 degrees, and 40 degrees, respectively, with respect to a vertical reference direction.

An armrest 18 associated with the seat 10 is adjustable in rotation so as to be able to extend in a horizontal plane whatever the position of the seat 10. The armrest 18 comprises an armrest arm 19 comprising a fixing interface 25 with the seat structure 14. The fixing interface 25 may comprise openings for the passage of fixing members, such as screws or rivets or any other fixing member suitable for the application.

An armrest body 20 visible in FIG. 4 has an upper face able to support a part of a passenger's body, in particular her/his arm. An axis 23 carried by the armrest arm 19 defines an axis of rotation X1 of the armrest body 20 relative to the armrest arm 19. The axis 23 can take for example the form of a rod fitted or screwed onto the armrest arm 19.

The armrest body 20 is preferably covered by a finishing covering 24, as shown in FIG. 3. The finishing covering 24 may be made of fabric, leather, velvet, alcantara or any other material suitable for finishing the armrest 18.

As can be seen in FIGS. 7a and 7b, a rotation adjustment device 27 for the armrest body 20 comprises a fixed element 28 which is fixed on the armrest arm 19. The fixed element 28 comprises a notched portion 29.1 for cooperating with a notched portion 29.2 of corresponding shape of a movable element 30 described in more detail below. More precisely, the fixed element 28 comprises an annular portion 28.1 provided with an opening for passage of the axis 23 so as to mount the fixed element 28 around the axis 23. The fixed element 28 is fixed on the armrest arm 19 by means of fixing members, such as screws, rivets, or a chemical fixing means such as glue, or any other fixing means suitable for the application. According to some embodiments, the fixed element 28 may constitute a portion of the armrest arm 19.

The notched portion 29.1 of the fixed element 28 is made on a projecting part 28.2 axially projecting from an end face of the annular portion 28.1. In the present description, the terms “axial” and “radial” are understood relative to a longitudinal extension direction of the axis 23. The notched portion 29.1 is made on a lateral face of the projecting part 28.2 of the fixed element 28. The face of the fixed element 28 on which the notched portion 29.1 is made has a helical shape.

Furthermore, the movable element 30 is linked in rotation to the body armrest 20 while being movable in translation relative to the armrest body 20 along the axis of rotation X1 of the armrest 18. For this purpose, the armrest body 20 carries rods 32 showing through in FIG. 4, each of them being inserted into a guide slot 33 of corresponding shape. The guide slots 33 visible in FIG. 6 are arranged on the external periphery of the movable element 30. The rods 32 have an axial orientation relative to the axis 23.

The movable element 30 comprises the notched portion 29.2 whose shape is complementary to that of the notched portion 29.1 of the fixed element 28. The fixed element 28 and the movable element 30 are mounted coaxially to one another.

More specifically, as can be seen in FIG. 6, the mobile element 30 comprises an annular portion 30.1 provided with an opening for passage of the axis 23. The notched portion 29.2 of the mobile element 30 is made on a projecting part 30.2 axially projecting from an end face of the annular portion 30.1. The notched portion 29.2 is made on a lateral face of the projecting part of the mobile element 30. The face of the mobile element 30 on which the notched portion 29.2 is made has a helical shape.

As shown in FIGS. 7a and 7b, the projecting portion 28.2 of the fixed element 28 and the projecting portion 30.2 of the movable element 30 are directed towards each other. Thus, the projecting portion 28.2 of the fixed element 28 is directed towards the movable element 30. The projecting portion 30.2 of the movable element 30 is directed towards the fixed element 28.

Each of the notched portion 29.2 of the movable element 30 and the notched portion 29.1 of the fixed element 28 has a plurality of stepped notches. Each notch corresponds to a step. The notched portions 29.1, 29.2 are sized so that an angular pitch is comprised between 2 and 5 degrees and preferably is of 2.5 degrees.

As can be seen in FIGS. 4 and 5, a disengaging device 35 is actuable by an actuating means 36. According to a preferred embodiment, the actuating means 36 is a button on a front face of the armrest body 20. Alternatively, the button may be arranged on a side face or an upper face of the armrest body 20. Alternatively, the actuating button 36 may be replaced with a lever or any other actuating means suitable for the application.

The disengaging device 35 is capable of taking a locked state in which the notched portion of the movable element 30 bears against the notched portion of the fixed element 28 (see FIG. 7a) in an angular stop position corresponding to a position of use of the armrest 18. Such a configuration blocks a rotation of the armrest body 20 in a first direction of rotation R1 around the axis of rotation X1 while allowing a rotation of the armrest body 20 around the axis of rotation X1 in a second direction of rotation R2 opposite to the first direction of rotation R1. Preferably, the first direction of rotation R1 corresponds to a clockwise direction when looking from the side at the armrest 18 directed to the right. The second direction of rotation R2 therefore corresponds to an anti-clockwise direction when looking from the side at the armrest 18 directed to the right. In the locked state, the armrest body 20 can no longer rotate downwards and the passenger can rest her/his arm on the armrest body 20.

As illustrated in FIG. 2, the armrest can take a stored position in which the armrest 18 forms an angle A2 of 0 degrees relative to the backrest 12. A position of use of the armrest 18 may be for example a “meal” position in which the armrest 18 forms an angle of 105 degrees relative to the backrest 12, a so-called TTL position (Taxi, Take-off, Landing) in which the armrest 18 forms an angle of 110 degrees relative to the backrest 12 or a reclined position in which the armrest 18 forms an angle of 130 degrees relative to the backrest 12. The positions of use of the armrest 18 are indicated with reference to the corresponding positions of the seat 10.

In the locked state, the notched portion 29.2 of the movable element 30 overlaps at least in part with the notched portion 29.1 of the fixed element 28 along a superposition zone 39. In this superposition zone 39, several notches of the movable element 30 cooperate with notches of corresponding shape of the fixed element 28. The length of the superposition zone 39 is variable according to the angular position of the armrest body 20.

In the second direction of rotation R2, there is no obstacle for the fixed element 28 so that the armrest body 20 can move freely backwards to the stored position in which the armrest 18 is located in an extension of the backrest 12. As can be seen in FIG. 8, the movable element 30 may comprise an angular stop 40 allowing to stop the armrest body 20 from rotating in the stored position. The angular stop 40 of the movable element 30 is provided for contacting a face of the projecting portion 28.2 of the fixed element 28 opposite the face comprising the notched portion 29.1.

The disengaging device 35 is also capable of taking a unlocked state in which the notched portion 29.2 of the movable element 30 is axially spaced from the notched portion 29.1 of the fixed element 28, as shown in FIG. 7b. This allows the rotation of the armrest body 20 in the first direction of rotation R1 downwards so as to modify the angular stop position.

Indeed, when the mobile element 30 is moved away from the fixed element 28, the rotation of the armrest body 20 forwards in the first direction of rotation R1 allows to carry out an angular offset of the notched portion 29.2 of the movable element 30 relative to the notched portion 29.1 of the fixed element 28. A release of the actuating means 36 then allows to make the notched portion 29.2 of the movable element 30 cooperate with the notched portion 29.1 of the fixed element 28, so that the disengaging device 35 returns to a locked state. The angular stop position of the armrest 18 is thus modified by adapting a length of the overlapping zone 39.

For this purpose, as can be seen in FIGS. 4, 5, and 6, the disengaging device 35 comprises a disengaging rod 41 movable in translation relative to the armrest body 20 and a connecting rod 42 whose first end is movable in rotation relative to the disengaging rod 41 and second end is movable in rotation relative to the movable element 30.

The disengaging device 35 comprises an elastic return member 43, such as a spring or any other element able to perform this function, between the disengaging rod 41 and the armrest body 20. In this case, the elastic return member 43 bears on the one hand against a ring 44 fixed on the disengaging rod 41 and on the other hand against a guide element 47 for guiding in translation the disengaging rod 41. The guide element 47 is fixed relative to the armrest body 20. The guide element 47 has for example a parallelepiped shape and comprises an opening for the passage of the disengaging rod 41. The guide element 47 is made so as to be (dis)mountable (for maintenance purposes) and to perform a function of guiding the rod 41, a function of recentering the two main parts forming the armrest body 20 and a function of supporting the elastic return member 43. The guide element 47 can therefore have any shape other than a parallelepiped shape allowing the aforementioned functions, in particular a cylindrical shape with or without a groove, shoulder or flattened surface.

It is given below with reference to FIGS. 10a, 10b, and 10c a description of an operation of the armrest 18 for example initially in a meal position (see FIG. 10a).

In the event that the passenger wishes to move the armrest 18 upwards in the stored position, the passenger can push the armrest body 20 upwards without pressing the actuating means 36.

As illustrated in FIG. 10b, when the passenger wishes to move the armrest body 20 downwards to the TTL position or reclined position, the passenger presses the actuating means 36 along the arrow F1, which has the effect of moving the disengaging rod 41 in translation towards the movable element 30 along the arrow F2 and compressing the elastic return member 43. The movement of the disengaging rod 41 causes the connecting rod 42 to rotate around the first end, which has the effect of moving the movable element 30 away from the fixed element 28 along the arrow F3. The passenger can then move the armrest body 20 into the desired position.

As illustrated in FIG. 10c, once the desired position reached, the passenger can release the actuation button 36, which has the effect of decompressing the elastic return member 43, which moves the disengaging rod 41 in translation in a direction opposite to the movable element 30 (see arrow F4). The movement of the disengaging rod 41 causes the connecting rod 42 to rotate around the first end, so that the movable element 30 approaches the fixed element 28 along the arrow F5. The notched portion 29.2 of the movable element 30 then cooperates with the notched portion 29.1 of the fixed element 28 so as to maintain the armrest body 20 in the desired position.

The further the armrest 18 is moved downwards, the greater the length of the overlapping zone 39 between the notched portions 29.1, 29.2 of the fixed element 28 and the movable element 30 decreases. Thus, as can be seen in FIG. 11, in the meal position P_din, the length of the overlapping zone 39 between the notched portion of the movable element 30 and the notched portion of the fixed element 28 is maximum while in the reclined position P_rel, the overlapping zone 39 between the notched portion of the movable element 30 and the notched portion of the fixed element 28 is minimum. The length of the overlapping zone 39 is intermediate in the TTL position. In FIG. 11, the angle A3 between the armrest and a vertical reference direction is 105 degrees, 110 degrees and 130 degrees respectively for the meal position P_din, the TTL position P_ttl and the reclined position P_rel.

Preferably, the force to be applied to the actuating means 36 for switching the disengaging device 35 from the locked state to the unlocked state is less than or equal to 10 Newtons.

As illustrated in FIG. 9, the armrest 18 may also comprise a friction disc 48 fixed on the armrest arm 19 for cooperating with the armrest body 20. This allows in particular to provide some resistance when moving the armrest 18 from one position to another while maintaining the armrest 18 in an intermediate position. The friction disc 48 is arranged on a side opposite to that comprising the device 27 for adjusting the rotation of the armrest 18.

Of course, the different characteristics, variants and/or embodiments of the present invention may be associated with each other in various combinations insofar as they are not incompatible with or exclusive of one another.

Furthermore, the invention is not limited to the embodiments described above and provided solely by way of example. It encompasses various modifications, alternative forms and other variants which a person skilled in the art may envisage in the context of the present invention and in particular any combination of the various operating modes described above may be taken separately or in combination.

1. An armrest for a seat comprising:
an armrest arm;
an armrest body able to support a part of the body of a passenger;
an axis carried by the armrest arm and defining an axis of rotation of the armrest body relative to the armrest arm;
a device for adjusting the rotation of the armrest body comprising:
a fixed element fixed to the armrest arm, said fixed element comprising a notched portion;
a movable element linked in rotation to the armrest body while being movable in translation relative to the armrest body along the axis of rotation of the armrest, said movable element comprising a notched portion whose shape is complementary to that of the notched portion of the fixed element; and
a disengaging device actuable by an actuating means, said disengaging device being capable of taking:
a locked state in which the notched portion of the movable element bears against the notched portion of the fixed element in an angular stop position so as to block a rotation of the armrest body in a first direction of rotation while allowing a rotation of the armrest body in a second direction of rotation opposite to the first direction of rotation; and
an unlocked state in which the notched portion of the movable element axially spaced from the notched portion of the fixed element so as to allow a rotation of the armrest body in the first direction of rotation so as to modify the angular stop position,
a transition from the locked state to the unlocked state being possible thanks to a translational movement of the movable element along the axis of rotation of the armrest body.

2. The armrest according to claim 1, wherein the disengaging device comprises a disengaging rod movable in translation relative to the armrest body and a connecting rod whose first end is movable in rotation relative to the disengaging rod and second end is movable in rotation relative to the movable element.

3. The armrest according to claim 2, wherein the disengaging device comprises an elastic return member between the disengaging rod and the armrest body.

4. The armrest according to claim 1, wherein each of the notched portion of the movable element and the notched portion of the fixed element has a plurality of stepped notches.

5. The armrest according to claim 1, wherein the notched portion of the fixed element is made on an axially projecting part of the fixed element and the notched portion of the movable element is made on an axially projecting part of the movable element.

6. The armrest according to claim 1, wherein the notched portion of the fixed element and the notched portion of the movable element are made on faces of helical shape.

7. The armrest according to claim 1, wherein the notched portions are dimensioned so as to allow an angular pitch of the armrest body between 2 and 5 degrees and preferably of 2.5 degrees.

8. The armrest according to claim 1, wherein the actuating means is a button on one face of the armrest body.

9. The armrest according to claim 1, further comprising a friction disc fixed on the armrest arm cooperating with the armrest body.

10. The armrest according to claim 1, wherein the armrest body carries rods respectively inserted into guide slots of corresponding shape provided at an external periphery of the movable element.

11. The armrest according to claim 1, wherein the armrest body is covered by a finishing covering.

12. An assembly comprising:
an airplane seat; and
an armrest as defined according to claim 1.

13. The assembly according to claim 12, wherein the airplane seat is movable between a raised position and a bed position.

14. An aircraft comprising an assembly as defined according to claim 12.
